(19) United States
(12) Patent Application Publication
(10) Pub. No.: US 2024/0128018 A1
(43) Pub. Date: Apr. 18, 2024

(54) HIGH-FREQUENCY COIL COMPONENT

(71) Applicant: TDK CORPORATION, Tokyo (JP)

(72) Inventors: Shigeki YANAGIDA, Tokyo (JP); Masashi GOTOH, Tokyo (JP); Shintarou KOIKE, Tokyo (JP); Junichiro URABE, Tokyo (JP)

(73) Assignee: TDK CORPORATION, Tokyo (JP)

(21) Appl. No.: 18/484,680

(22) Filed: Oct. 11, 2023

(30) Foreign Application Priority Data
Oct. 14, 2022 (JP) 2022-165620

(51) Int. Cl. H01F 27/32

(52) U.S. Cl. CPC H01F 27/327

(57) ABSTRACT

A high-frequency coil component includes a sealing portion containing a resin and a plurality of hollow particles, and a coil portion composed of a wound conductive wire. The coil portion is sealed in the sealing portion. The resin includes a low-dielectric resin having a relative permittivity εᵣ₁ of 2.00 or more and less than 3.00 at 23±2° C. A mass of the resin is represented by Mr. A total mass of the plurality of hollow particles is represented by Mp. Mr/(Mr+Mp) is 25% or more and 85% or less.

### CROSS-REFERENCE TO RELATED APPLICATION

This application claims priority to Japanese patent application No. 2022-165620 filed on Oct. 14, 2022 and is incorporated herein by reference in its entirety.

### TECHNICAL FIELD

The present disclosure relates to a high-frequency coil component.

### BACKGROUND

As a small high-frequency coil component (such as an inductor) used in a high-frequency circuit, a Multilayer coil component described in Japanese Unexamined Patent Publication No. 2014-24735 is known. The multilayer coil component includes a plurality of conductive wire patterns stacked via an insulating layer.

### SUMMARY

For example, one aspect of the disclosure relates to the following high-frequency coil component.

A high-frequency coil component, including: a sealing portion containing a resin and a plurality of hollow particles; and a coil portion composed of a wound conductive wire, in which the coil portion is sealed in the sealing portion, the resin includes a low-dielectric resin having a relative permittivity εᵣ₁ of 2.00 or more and less than 3.00 at 23±2° C., a mass of the resin is represented by Mr, a total mass of the plurality of hollow particles is represented by Mp, and Mr/(Mr+Mp) is 25% or more and 85% or less.

### BRIEF DESCRIPTION OF THE DRAWINGS

FIG. 1 is a schematic perspective view of a high-frequency coil component according to one embodiment of the disclosure.

FIG. 2 is a schematic cross-section of the high-frequency coil component illustrated in FIG. 1, and the cross-section illustrated in FIG. 2 includes a central axis line of a coil portion and traverses a pair of terminal electrodes of the high-frequency coil component.

### DETAILED DESCRIPTION

As a high-frequency coil component having a structure different from that of the multilayer coil component, a coil component (a wire wound coil component) composed of a wire wound coil (a coil portion) sealed in a resin is also known. The general resin used for production of the conventional wire wound coil component has a comparatively high surface tension. Due to the high surface tension of the resin, air is easily involved in the resin during a molding step to seal the wire wound coil in the resin, and voids are easily formed in the resin. The voids in the resin cause deterioration and variation in properties such as a mechanical strength of the wire wound coil component.

In addition, since the general resin used for production of the conventional wire wound coil component is transparent, in a case where a colorant or the like is not used, the coil portion sealed in the resin is visually recognized from the outside, and an appearance (sensuousness or estheticity) of the wire wound coil component is impaired. Due to diffused reflection of light, which is caused by the coil portion sealed in the transparent resin, handleability of the coil portion at the time of mounting the wire wound coil component on an electronic circuit is impaired. From such reasons, it is desirable that the resin in which the coil portion is sealed is opaque.

In addition, it is desirable for the wire wound coil component to achieve a Q value (a quality factor) higher than that of the conventional component in a high-frequency band and to suppress a power loss (a dielectric loss). In general, the Q value is a dimensionless quantity represented by (2πfL)/R. f is a frequency of an alternating electric current, L is an inductance of the wire wound coil component, and R is a resistance component of the coil portion.

An object of one aspect of the disclosure is to provide an opaque high-frequency coil component having a high mechanical strength and a high Q value.

Hereinafter, a preferred embodiment of the disclosure will be described with reference to the drawings. In the drawings, the equivalent reference numerals are applied to the equivalent constituents. The disclosure is not limited to the following embodiment.

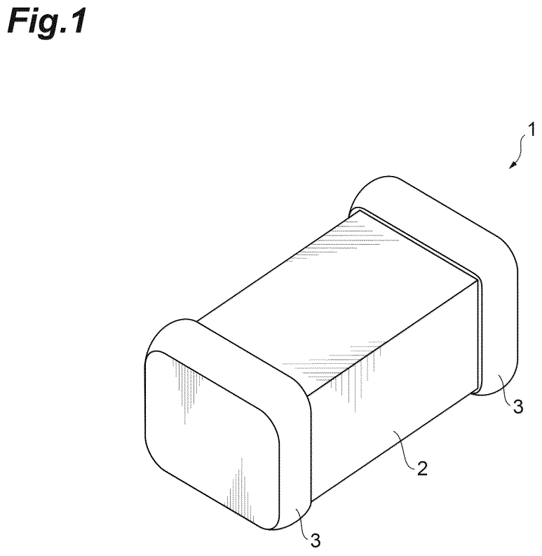

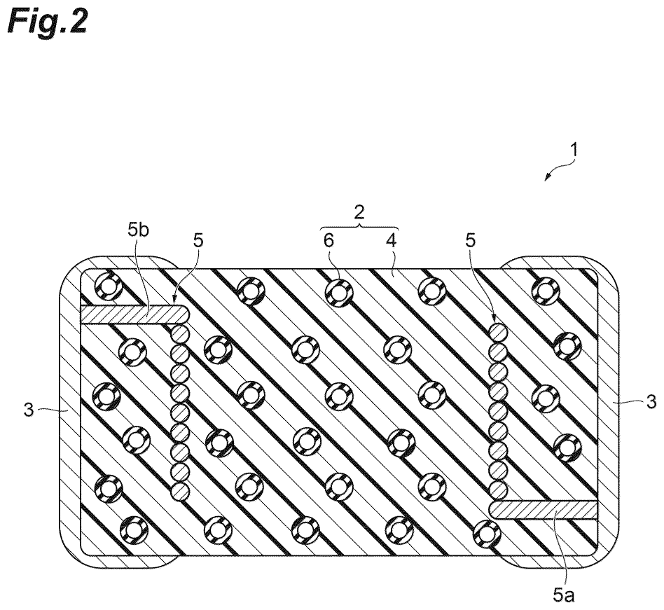

As illustrated in FIG. 1 and FIG. 2, a high-frequency coil component 1 according to this embodiment includes a sealing portion 2, a coil portion 5, and a pair of terminal electrodes 3. A frequency band in which the high-frequency coil component 1 is used, for example, may be 1 GHz or more and 10 GHz or less, 2 GHz or more and 7 GHz or less, or 3 GHz or more and 7 GHz or less. A dimension of the high-frequency coil component 1 is not limited. For example, each of a maximum width and a minimum width of the high-frequency coil component 1 may be several hundred μm or more and several mm or less. For example, the high-frequency coil component 1 may be a chip component with 3225 size (3.2 mm×2.5 mm), 3216 size (3.2 mm×1.6 mm), 2012 size (2.0 mm×1.2 mm), 1608 size (1.6 mm×0.8 mm), 1005 size (1.0 mm×0.5 mm), 0603 size (0.6 mm×0.3 mm), or 0402 size (0.4 mm×0.2 mm).

The coil portion 5 is composed of a wound conductive wire. That is, the high-frequency coil component 1 is different from a multilayer coil component in that the coil portion 5 is a wire wound coil. A number of windings (turn number) of the coil portion 5 is not limited. The entire coil portion 5 is sealed (embedded) in the sealing portion 2. Here, an end portions of the coil portion 5 (tips of extraction portions 5a and 5b) connected to the terminal electrodes 3 do not have to be sealed (embedded) in the sealing portion 2. The coil portion 5 before being sealed in the sealing portion 2 is an air core coil, but the inside of the coil portion 5 sealed in the sealing portion 2 is filled with the sealing portion 2. While the shape of the sealing portion 2 is not limited, the sealing portion 2 illustrated in FIG. 1 and FIG. 2 is a cuboid. The sealing portion 2 has a first end surface and a second end surface facing each other, one terminal electrode 3 covers the first end surface, and the other terminal electrode 3 covers the second end surface. One end portion (the extraction portion 5a) of the coil portion 5 is electrically connected to one terminal electrode 3, and the other end portion (the extraction portion 5b) of the coil portion 5 is electrically connected to the other terminal electrode 3.

The structure of the high-frequency coil component 1 is not limited to the structure illustrated in FIG. 1 and FIG. 2. For example, the pair of terminal electrodes 3 may be formed in one side surface of the sealing portion 2, or one terminal electrode 3 may be disposed on one end side of one side surface, and the other terminal electrode 3 may be disposed on the other end side of the same side surface. That is, the pair of terminal electrodes 3 may be formed on one side surface of the sealing portion 2, and the pair of terminal electrodes 3 may fit within one side surface of the sealing portion 2.

The sealing portion 2 contains a resin 4 and a plurality of hollow particles 6 (a powder consisting of hollow particles 6). Each one of the hollow particles 6 is an insulating particle including a void. The sealing portion 2 may consist only of the resin 4 and the plurality of hollow particles 6. The plurality of hollow particles 6 may be approximately homogeneously dispersed in the sealing portion 2.

Even in a case where the resin 4 itself and the hollow particles 6 themselves are transparent, refraction or diffusion of light (visible light) in the sealing portion 2 is likely to occur due to the plurality of hollow particles 6 in the sealing portion 2. As a result, it is difficult for the light to go straight ahead in the sealing portion 2, and it is possible to make the sealing portion 2 and the entire high-frequency coil component 1 opaque.

The resin 4 includes a low-dielectric resin having a relative permittivity εᵣ₁ of 2.00 or more and less than 3.00 at 23±2° C. A part of the resin 4 may be the low-dielectric resin, or the entire resin 4 may be the low-dielectric resin. Since the hollow particles 6 include the voids, a relative permittivity of the hollow particles 6 themselves is close to a relative permittivity (approximately 1.00) of air. Further, the relative permittivity εᵣ₁ of the low-dielectric resin at 23±2° C. is less than 3.00. From such reasons, it is possible for the sealing portion 2 to have a low relative permittivity, it is possible for the high-frequency coil component 1 to have a high Q value in the high-frequency band described above, and it is possible to reduce a power loss in the high-frequency coil component 1. As the relative permittivity εᵣ₁ of the low-dielectric resin at 23±2° C. is lower, the Q value easily increases. However, a low-dielectric resin having the relative permittivity εᵣ₁ of less than 2.00 at 23±2° C. has not been found yet by the inventors. In a case where the relative permittivity εᵣ₁ of the low-dielectric resin is 3.00 or more, it is difficult for the high-frequency coil component 1 to have a high Q value.

A relative permittivity εᵣ₂ of the sealing portion 2 at 23±2° C. may be 1.00 or more and 2.34 or less, or 2.01 or more and 2.34 or less. Since the relative permittivity εᵣ₂ of the sealing portion 2 at 23±2° C. is 2.34 or less, it is easy for the high-frequency coil component 1 to have a high Q value in the high-frequency band described above, and it is easy to reduce the power loss in the high-frequency coil component 1. The relative permittivity εᵣ₂ of the sealing portion 2 depends on a relative permittivity of the resin 4 (the relative permittivity εᵣ₁ of the low-dielectric resin), the relative permittivity of the hollow particles 6 themselves, and a mass ratio or a volume ratio of each of the resin 4 (the low-dielectric resin) and the hollow particles 6. On the basis of such factors, the relative permittivity εᵣ₂ of the sealing portion 2 can be freely adjusted.

A mass of the resin 4 is represented by Mr, and a total mass of the plurality of hollow particles 6 is represented by Mp. Mr/(Mr+Mp) is 25% or more and 85% or less, and Mp/(Mr+Mp) is 15% or more and 75% or less. Since Mr/(Mr+Mp) is 25% or more and 85% or less, it is possible to make a high mechanical strength and a high Q value compatible, and it is also possible to make the high-frequency coil component 1 opaque. From the same reason, Mr/(Mr+Mp) may be 30% or more and 80% or less, and Mp/(Mr+Mp) may be 20% or more and 70% or less. Mr/(Mr+Mp) may be 30% or more and 70% or less, and Mp/(Mr+Mp) may be 30% or more and 70% or less.

Since the hollow particles 6 include the voids, there is a tendency that the relative permittivity of the hollow particles 6 themselves is close to the relative permittivity (approximately 1.00) of air, and is lower than the relative permittivity εᵣ₁ of the low-dielectric resin. Accordingly, there is a tendency that the relative permittivity εᵣ₂ of the sealing portion 2 decreases, and the Q value increases, in accordance with an increase in Mp/(Mr+Mp) (a ratio of the hollow particles 6 in the sealing portion 2). In other words, there is a tendency that the relative permittivity εᵣ₂ of the sealing portion 2 increases, and the Q value decreases, in accordance with a decrease in Mr/(Mr+Mp) (a ratio of the resin 4 in the sealing portion 2). However, in a case where Mr/(Mr+Mp) is less than 25% (in a case where Mp/(Mr+Mp) is higher than 75%), since a viscosity of a mixture containing the uncured resin 4 and the hollow particles 6 (a raw material of the sealing portion 2) excessively increases, and it is difficult to seal the coil portion 5 in the sealing portion 2 in a molding step. Further, in a case where Mr/(Mr+Mp) is less than 25% (in a case where Mp/(Mr+Mp) is higher than 75%), since the hollow particles 6 in the raw material of the sealing portion 2 are too much, the mixture hardly flows, and a large load is applied to the hollow particles 6 due to friction or the like, which makes the hollow particles 6 easy to be cracked. As a result, the voids, which are the factor of a low relative permittivity, decrease, the relative permittivity εᵣ₂ of the sealing portion 2 easily increases, and the Q value easily decreases.

On the other hand, in a case where Mr/(Mr+Mp) is higher than 85% (in a case where Mp/(Mr+Mp) is less than 15%), the hollow particles 6 in the sealing portion 2 are too little. As a result, it is difficult to make the sealing portion 2 and the entire high-frequency coil component 1 opaque, the relative permittivity εᵣ₂ of the sealing portion 2 easily increases, and the Q value easily decreases. Further, in a case where Mr/(Mr+Mp) is too high, a problem such as deformation of the sealing portion 2 is likely to occur when the high-frequency coil component is mounted on a circuit substrate or the like by soldering. In addition, in a case where Mr/(Mr+Mp) is too high, the mechanical strength of the high-frequency coil component 1 (the sealing portion 2) is likely to vary, and a standard deviation of the mechanical strengths easily increases.

There is a tendency that thermal expansion of the sealing portion 2 is suppressed in accordance with an increase in Mp/(Mr+Mp) (the ratio of the hollow particles 6 in the sealing portion 2).

A volume of the resin 4 is represented by Vr, and a total volume of the plurality of hollow particles 6 is represented by Vp. Vp includes a volume of the void in each of the hollow particles 6. Vr/(Vr+Vp) may be 17% or more and 78% or less, and Vp/(Vr+Vp) may be 22% or more and 83% or less. Vr/(Vr+Vp) may be 20% or more and 60% or less, and Vp/(Vr+Vp) may be 40% or more and 80% or less. The technical significance of each of upper and lower limit values of Vr/(Vr+Vp) is the same as the technical significance of each of upper and lower limit values of Mr/(Mr+Mp) described above. The technical significance of each of upper and lower limit values of Vp/(Vr+Vp) is the same as the technical significance of each of upper and lower limit values of Mp/(Mr+Mp) described above.

A method for measuring each of the relative permittivity εᵣ₁ of the low-dielectric resin and the relative permittivity εᵣ₂ of the sealing portion 2 is not limited. For example, each of εᵣ₁ and εᵣ₂ may be measured by a resonance method such as a harmonic resonator perturbation method. For example, each of εᵣ₁ and εᵣ₂ may be measured by a resonance method described in Non-Patent Literature described below. In the resonance method, an electromagnetic wave is incident on a resonator via an excitation line, and a specific electromagnetic field mode is excited in the resonator. Then, a resonance frequency is specified from the measurement of a transmission amount (an S parameter) of the electromagnetic wave between two excitation lines. A relative permittivity (a real part of a complex permittivity) of a sample is derived from a difference (a change amount of the resonance frequency) between a resonance frequency in a case where there is the sample in the resonator and a resonance frequency in a case where there is no sample in the resonator. The resonance frequency at which each of εᵣ₁ and εᵣ₂ is measured, for example, may be 1 GHz or more and 10 GHz or less, 2 GHz or more and 7 GHz or less, or 3 GHz or more and 7 GHz or less. <Non-Patent Literature> Yuto KATO, A survey on measurement techniques of dielectric properties and dissemination of their national standards, AIST Bulletin of Metrology Vol. 9, No. 1, March 2014, issued by National Metrology Institute of Japan, National Institute of Advanced Industrial Science and Technology

The resin 4 may include a plurality of kinds of resins. The resin 4 may include one or both of a thermosetting resin and a thermoplastic resin. The resin 4 may include one kind of low-dielectric resin, or the resin 4 may include a plurality of kinds of low-dielectric resins. The low-dielectric resin included in the resin 4 is not limited as long as the resin has the relative permittivity εᵣ₁ of 2.00 or more and less than 3.00 at 23±2° C. For example, the low-dielectric resin may be at least one kind of thermosetting resin selected from the group consisting of polyimide, polyphenylene ether, a low-permittivity bismaleimide-triazine (BT) resin, special cyanate, and an epoxy resin. For example, the low-dielectric resin may be at least one kind of thermoplastic resin selected from the group consisting of polytetrafluoroethylene, polyethylene, polypropylene, polystyrene, polyphenylene ether, polycarbonate, and polyarylate. Here, not all kinds of resins described above are usable as the low-dielectric resin. Among all kinds of resins described above, a resin having the relative permittivity εᵣ₁ of 2.00 or more and less than 3.00 at 23±2° C. is usable as the low-dielectric resin. For example, not all kinds of polyimides are usable as the low-dielectric resin. Among all kinds of polyimides, a polyimide having the relative permittivity εᵣ₁ of 2.00 or more and less than 3.00 at 23±2° C. is usable as the low-dielectric resin. Not all kinds of epoxy resins are usable as the low-dielectric resin. Among all kinds of epoxy resins, an epoxy resin having the relative permittivity εᵣ₁ of 2.00 or more and less than 3.00 at 23±2° C. is usable as the low-dielectric resin.

The low-dielectric resin may include a thermosetting polyimide. Since the low-dielectric resin includes the thermosetting polyimide, it is easy to make a high mechanical strength and a high Q value of the high-frequency coil component 1 compatible, and it is easy to improve thermal resistance of the high-frequency coil component 1. From the same reason, the thermosetting polyimide may include a polybismaleimide (a bismaleimide resin). The polybismaleimide is a copolymer formed from bismaleimides and a comonomer. The bismaleimides are compounds having an arbitrary organic group, and two or more maleimide rings bonded to the organic group. Each of a pair of carbons composing a carbon-carbon double bond in the maleimide ring may be independently bonded to a monovalent atom selected from hydrogen or halogen, or a monovalent organic group. The arbitrary organic group of the bismaleimides may have a maleimide ring. In a case where at least a part of the arbitrary organic group has a maleimide ring, since the bismaleimides and the copolymer are three-dimensionally polymerized, it is easy to improve the mechanical strength and the thermal resistance of the high-frequency coil component 1. For example, the comonomer polymerized with the bismaleimides may be at least one kind of compound selected from the group consisting of a vinyl compound, an aryl compound, aryl phenols, isocyanates, and aromatic amines.

For example, the following commercially available raw material monomers, raw material oligomers, raw material mixtures, or the like (all of these are uncured materials) of the polybismaleimide may be used as the raw material of the low-dielectric resin. All of BMI-2500, BMI-2560, BMI-3000J, BMI-6100, DMI-2550, and DMI-2555 described below are raw materials of the polybismaleimide, produced by Designer Molecules, Inc.

<BMI-2500>

Relative permittivity εᵣ₁ at 23±2° C.: approximately 2.30 or more and 2.32 or less.

CAS number: 2020378-57-6.

Composition: 1,1′-(octahydro-1H-4,7-methanoindene-2,5-diyl) dimethane amine (dimer diamine (limited to dimer diamine having an aminomethyl group instead of a carboxy group) obtained by reducing and aminating a cyclic dimer acid (having C=36 as a main component) obtained as a dimer of an unsaturated fatty acid (C=18))-furan-2,5-dione-1H,3H-benzo[1,2-c:4,5-c′]difuran-1,3,5,7-tetraone polycondensate.

(BMI-2500: Amines, C36-alkylenedi-, polymers with octahydro-4,7-methano-1H-indenedimethanamine and pyomellitic dianhydride, maleated.)

<BMI-2560>

Relative permittivity εᵣ₁ at 23±2° C.: approximately 2.5.

CAS number: 2126832-79-7.

Composition: Amines, C36-alkylenedi-, reaction products with maleic anhydride and 4,4′-methylenebis[2-methylcyclohexane amine]-5,5′-oxybis[1,3-isobenzofurandione] polymer

<BMI-3000J>

Relative permittivity εᵣ₁ at 23±2° C.: approximately 2.44 or more and 2.47 or less.

CAS number: 921213-77-6.

Composition: (1,2-bis(octyl maleimide)-3-octyl-4-hexyl) cyclohexyl oligomer.

(BMI-3000J: Amines, C36-alkylenedi-, polymers with pyromellitic dianhydride, maleated)

<BMI-6100>

Relative permittivity εᵣ₁ at 23±2° C.: approximately 2.85 or more and 2.89 or less.

CAS number: 2127116-97-4.

Composition: 1,3-Isobenzofurandione, 5,5′-[(1-methylethylidene)bis(4,1-phenyleneoxy)]bis-, polymer with 4,4′-methylenebis[2,6-diethylbenzenamine], reaction products with maleic anhydride and 4,4′-[(1-methylethylidene)bis(4,1-phenyleneoxy)]bis[benzenamine]

<DMI-2550, DMI-2555>

Relative permittivity εᵣ₁ at 23±2° C.: 2.00 or more and less than 3.00.

CAS number: 1911605-95-2.

Composition: 1H-Pyrrole-2,5-dione, 1,1′-C36-alkylenebis-Dicumyl Peroxide

The hollow particles 6 may include at least one kind of compound selected from the group consisting of a glass, a ceramic, and a polymer. The sealing portion 2 may contain a plurality of kinds of hollow particles 6 differing in their compositions. The glass is more excellent in a low relative permittivity than the ceramics. Further, the glass is more excellent in a high mechanical strength than the polymer. In a case where the resin 4 contained in the sealing portion 2 is a liquid crystal polymer, since the hollow particles 6 in the liquid crystal polymer are easily cracked, it is difficult to adjust a ratio (Vp/(Vr+Vp) described above) of the hollow particles 6 in the liquid crystal polymer to 50% or more. On the other hand, since the hollow particles 6 consisting of the glass are less likely to be cracked, it is possible to adjust a volume ratio (Vp/(Vr+Vp) described above) of the hollow particles 6 consisting of the glass to 50% or more. Accordingly, in a case where the hollow particles 6 consist of the glass, it is easy to decrease the relative permittivity εᵣ₂ of the sealing portion 2 by increasing the volume ratio of the hollow particles 6. From such reasons, it is preferable that the hollow particles 6 contain the glass. A composition of the glass composing the hollow particles 6 is not limited. For example, the glass composing the hollow particles 6 may be at least one kind of compound selected from the group consisting of an alumina borosilicate glass, a soda lime borosilicate glass, a borosilicate glass, a silicate glass, a soda lime glass, a quartz glass, and an organic glass. For example, the organic glass may be an acrylic resin such as polymethyl methacrylate, or a polycarbonate such as polydiethylene glycol bisaryl carbonate. As an example of commercially available hollow particles 6, CellSpheres (hollow particles including alumina borosilicate glass), produced by TAIHEIYO CEMENT CORPORATION, or 3M Glass Bubbles (hollow particles including soda lime borosilicate glass), produced by 3M Japan Limited, may be used. The hollow particles 6 may be referred to as hollow glass, glass balloon, glass bubble, hollow bead, or micro balloon.

A particle diameter (an average particle diameter) of the hollow particles 6 may be 1 μm or more and 30 μm or less, 1 μm or more and 20 μm or less, 1 μm or more and 5 μm or less, or 3 μm or more and 4 μm or less. As the particle diameter of the hollow particles decreases, it is easier to miniaturize the high-frequency coil component 1. As the particle diameter of the hollow particles 6 decreases, the hollow particles 6 are easily aggregated in a production procedure of the high-frequency coil component 1, and the viscosity of the raw material (the mixture including the uncured resin 4 and the hollow particles 6) of the sealing portion 2 tends to increase. A relative permittivity of the entire hollow particles 6 including voids, for example, may be 1.2 or more and 2.1 or less. A hollowness of the hollow particles 6 (a volume ratio of the voids in the hollow particles 6), for example, may be 50% by volume or more and 95% by volume or less, 55% by volume or more and 90% by volume or less, or 60% by volume or more and 80% by volume or less.

The sealing portion 2 may further contain other components such as a curing agent, a curing accelerator (a curing catalyst), and a silane coupling agent (a surfactant), or a compound derived therefrom. In a case where the raw material of the sealing portion 2 further includes the silane coupling agent in addition to the uncured resin 4 and the hollow particles 6, in the production procedure of the high-frequency coil component 1, the hydrophobic resin 4 is easily bonded to the surface of the hydrophilic hollow particles 6 via the amphiphilic silane coupling agent. As a result, a surface tension of the uncured resin 4 is suppressed, air is less likely to be involved in the resin 4 during a molding step, and the formation of voids in the resin 4 is easily suppressed. In addition, since the resin 4 is bonded to the surface of the hollow particles 6 via the silane coupling agent, the mechanical strength of each of the sealing portion 2 and the high-frequency coil component 1 easily increases.

A composition of the conductive wire composing the coil portion 5 is not limited. For example, the conductive wire composing the coil portion 5 may include at least one kind of metal element selected from the group consisting of copper (Cu), silver (Ag), nickel (Ni), and chromium (Cr). The surface of the conductive wire composing the coil portion 5 may be covered with an insulating layer such as polyurethane.

A composition of the terminal electrode 3 is not limited. For example, the terminal electrode 3 may include at least one kind of metal element selected from the group consisting of silver (Ag), tin (Sn), copper (Cu), and nickel (Ni). An alloy including such metal elements may compose the terminal electrode 3. The terminal electrode 3 may include a plurality of metal layers stacked on the surface of the sealing portion 2.

In the molding step described above, vacuum molding may be used. The vacuum molding may be performed in the following procedure.

First, slurry or paste is prepared by mixing the uncured resin 4, the hollow particles 6, and an organic solvent, as the raw materials of the sealing portion 2. In a case where the uncured resin 4 itself is a liquid, the organic solvent does not have to be used. The slurry or the paste may further include additives such as a curing agent, a curing accelerator (a curing catalyst), a silane coupling agent (a surfactant), and a wax (a lubricant).

The coil portion 5 is provided in a cavity of a mold. Subsequently, the slurry or the paste is filled in the cavity. The mold filled with the slurry or the paste is put in an oven. The slurry or the paste filled in the mold, for example, is dried in the state of being heated by the oven to obtain a semi-cured molded body. Next, the molded body under a pressure is heated by using a vacuum molding machine to cure the semi-cured molded body. As a result, the sealing portion 2 in which the coil portion 5 is sealed by the resin 4 is formed.

In a case where the uncured resin 4 itself is a liquid, and the solvent is not used, the drying for semi-curing does not have to be performed after filling the cavity with the slurry or the paste. By pressing and heating the slurry or the paste filled in the mold with the vacuum molding machine, the sealing portion 2 in which the coil portion 5 is sealed is formed.

In a case of sealing the coil portion with a thermoplastic resin, injection molding may be used in the molding step. In a case where the resin 4 is only the thermoplastic resin, a curing agent and a curing accelerator does not have to be used.

After the molding step, the pair of terminal electrodes 3 are formed on the surface of the sealing portion 2 to obtain the high-frequency coil component 1. A method for forming the terminal electrodes 3, for example, may be a method such as applying and baking a conductive paste, an electrolytic plating, and an electroless plating, or a combination thereof. Before the terminal electrodes 3 are formed, a dimension of the sealing portion 2 may be adjusted by cutting the sealing portion 2.

The present disclosure is not necessarily limited to the aforementioned embodiments. Various modifications of the present disclosure are possible without departing from the gist of the present disclosure, and these modified examples are also included in the present disclosure.

### EXAMPLES

The disclosure will be explained in detail by Examples and Comparative Examples described below. The disclosure is not limited by Examples described below.

### Example 1

<Measurement of Relative Permittivity εᵣ₂ of Sealing Portion at 23±2° C.>

[Step 1] 0.6 g of dicumyl peroxide (DCP) was dissolved in 30 g of tetralin (1,1,2,2-tetrahydronaphthalene) to prepare a solution. The tetralin was produced by JUNSEI CHEMICAL CO., LTD. The dicumyl peroxide was produced by NOF CORPORATION.

[Step 2] 30 g of a bismaleimide resin was dissolved in the solution. As the bismaleimide resin, BMI-3000J described above was used. The bismaleimide resin corresponds to a low-dielectric resin before curing.

[Step 3] A powder consisting of hollow particles is added to the solution prepared in step 2. As the hollow particles, CellSpheres (hollow particles including alumina borosilicate glass) produced by TAIHEIYO CEMENT CORPORATION were used. A mass ratio and a volume ratio of each of the bismaleimide resin (the low-dielectric resin) and the hollow particles were adjusted to values shown in Table 1 described below.

The mass ratio of the low-dielectric resin in Table 1 and Table 2 described below corresponds to Mr/(Mr+Mp) described above. The volume ratio of the low-dielectric resin in Table 1 and Table 2 described below corresponds to Vr/(Vr+Vp) described above.

The mass ratio of the hollow particles in Table 1 and Table 2 described below corresponds to Mp/(Mr+Mp) described above. The volume ratio of the hollow particles in Table 1 and Table 2 described below corresponds to Vp/(Vr+Vp) described above.

Furthermore, a silane coupling agent was added to the solution, and the solution was stirred. As the silane coupling agent, KBM-303 and KBM-573, produced by Shin-Etsu Chemical Co., Ltd., were used. KBM-303 is 2-(3,4-epoxy cyclohexyl) ethyl trimethoxy silane. KBM-573 is N-phenyl-3-aminopropyl trimethoxy silane. A mass ratio of KBM-303 was 1 part by mass with respect to 100 parts by mass of the hollow particles. A mass ratio of KBM-573 was also 1 part by mass with respect to 100 parts by mass of the hollow particles.

A raw material (paste) of a sealing portion of Example 1 was prepared by the steps described above.

[Step 4] The raw material was dried at 100° C. for 24 hours to obtain a semi-cured material.

[Step 5] A substrate was made from the semi-cured material by a molding step using a vacuum molding machine. The substrate corresponds to a sealing portion in which a coil portion is not sealed. A molding pressure was 0.6 MPa. In order to thermally cure the resin in the sealing portion, the pressed raw material was heated at 150° C. for 0.5 hours and then heated at 200° C. for 1 hour in the molding step. A dimension of the substrate was vertical width of 130 mm×horizontal width of 50 mm×thickness of 1 mm.

[Step 6] A square bar was cut out from the substrate. A dimension of the square bar was vertical width of 130 mm×horizontal width of 1 mm×thickness of 1 mm.

[Step 7] A relative permittivity εᵣ₂ of the square bar (the sealing portion) at 23±2° C. was measured by a harmonic resonator perturbation method. The relative permittivity εᵣ₂ was measured at each resonance frequency of 3.4 GHz, 5.3 GHz, and 7.0 GHz. For the measurement of the relative permittivity εᵣ₂, a measurement system produced by Kanto Electronics Application Development Co., Ltd. (Current Company Name: EM labs, Inc.) was used. The relative permittivity εᵣ₂ of Example 1 is shown in Table 1 described below.

<Measurement of Coefficient of Thermal Expansion>

The substrate was produced by steps 1 to 5 described above. A measurement sample (a small substrate) was cut out from the substrate. A dimension of the sample was vertical width of 5 mm×horizontal width of 5 mm×thickness of 1 mm. A displacement amount of the sample in a range of −20° C. to 290° C. was measured, and a coefficient of thermal expansion (Unit: ppm/K) of the sample was calculated from the displacement amount. The displacement amount of the sample was measured in a nitrogen atmosphere. A temperature increase rate of the sample was 10° C./minute. For the measurement of the displacement amount, a thermal mechanical analyzer (TMA7000) produced by Hitachi High-Tech Science Corporation was used. The coefficient of thermal expansion of Example 1 is shown in Table 1 described below.

<Evaluation of Thermal Resistance>

The square bar was produced by steps 1 to 6 described above. The square bar was immersed in a molten solder bath for 10 seconds, and then the square bar was observed. None of an appearance defect, a color change, and deformation of the square bar due to the immersion in the solder bath occurred. A temperature of the solder bath was 300° C. As the solder, lead-free solder (M705) produced by SENJU METAL INDUSTRY CO., LTD. was used. M705 is an alloy consisting of 3.0% by mass of Ag, 0.5% by mass of Cu, and the balance of Sn.

<Measurement of Three-Point Bending Strength>

The dried raw material (semi-cured material) was prepared by steps 1 to 4 described above. A sheet was made from the dried raw material by a molding step using the vacuum molding machine. The sheet corresponds to the sealing portion in which the coil portion is not sealed. A molding pressure was 0.6 MPa. The pressed raw material was heated at 150° C. for 0.5 hours and then heated at 200° C. for 1 hour in the molding step. A dimension of the sheet was vertical width of 50 mm×horizontal width of 50 mm×thickness of 0.2 mm. A sample in a rectangular shape was cut out from the sheet. A dimension of the sample was vertical width of 20 mm×horizontal width of 5 mm×thickness of 0.2 mm. A three-point bending strength (Unit: MPa) of the sample was measured. For the measurement of the three-point bending strength, a desktop-type precision universal tester (Autograph AGS-5kNX) produced by SHIMADZU CORPORATION was used. A load of a load cell was 1 kN. A distance between pivot points was 5 mm. A movement speed of the load cell was 0.5 mm/minute. The three-point bending strength (an average value of 10 samples) of Example 1 is shown in Table 1 described below.

Three-point bending strengths of a total of 10 samples were measured by the method described above, and a standard deviation of the three-point bending strengths was calculated. The standard deviation of the three-point bending strengths of Example 1 is shown in Table 1 described below.

<Evaluation of Transparency and Measurement of Q Value>

The raw material (the paste) of the sealing portion of Example 1 was prepared by steps 1 to 3 described above.

A coil portion (air core coil) composed of a wound copper wire was prepared. A diameter of the cross section of the copper wire was 25 μm. The surface of the copper wire was covered with a polyurethane-based insulating layer. A thickness of the insulating layer was 4 μm.

A plurality of coil portions were provided in the cavity of the mold. The paste described above was filled in the cavity. The coil portion and the paste in the cavity were dried at 100° C. for 24 hours in air to obtain a sealing sheet in which the coil portions are sealed. After drying in air, the sealing sheet in the vacuum molding machine was heated at 150° C. for 0.5 hours and further heated at 200° C. for 1 hour to cure the resin in the sealing sheet. A dimension of the sealing sheet after curing the resin was vertical width of 20 mm×horizontal width of 20 mm×height of 0.2 mm. After curing the resin, a cuboidal sealing portion (high-frequency coil component) in which one coil portion was sealed was cut out from the sealing sheet. A dimension of the high-frequency coil component was vertical width of 0.4 mm×horizontal width of 0.2 mm×height of 0.2 mm.

It was not possible to visually recognize the coil portion in the high-frequency coil component. That is, the sealing portion in which the coil portion is sealed was opaque. “Opaque” in Table 1 and Table 2 described below indicates that it is not possible to visually recognize the coil portion in the high-frequency coil component. “Transparent” in Table 1 and Table 2 described below indicates that it is possible to visually recognize the coil portion in the high-frequency coil component.

An S parameter of the high-frequency coil component at 1 to 20 GHz was measured. For the measurement of the S parameter, a network analyzer (E5071C) produced by Keysight Technologies was used. On the basis of the measured S parameter, a Q value at each of 3 GHz, 5 GHz, and 7 GHz was calculated. The Q values of Example 1 are shown in Table 1 described below.

### Examples 2 to 7 and Comparative Examples 1 to 7

In the cases of Example 6 and Comparative Example 4, BMI-6100 was used instead of BMI-3000J as the low-dielectric resin. Uncured BMI-6100 is a solution of a bismaleimide resin containing 70% by mass of anisole.

In the cases of Example 6 and Comparative Example 4, the tetralin was not used, and a solution was prepared by mixing 50 g of BMI-6100 and 0.3 g of dicumyl peroxide before step 3 described above.

In the cases of Example 7 and Comparative Example 5, BMI-2500 (another bismaleimide resin) was used instead of BMI-3000J as the low-dielectric resin.

In the cases of Comparative Examples 6 and 7, an epoxy resin was used instead of BMI-3000J. That is, in the case of Comparative Examples 6 and 7, 28.7 g of a solution of the epoxy resin and 34.3 g of a solution of a curing agent were mixed instead of steps 1 and 2 described above. As the solution of the epoxy resin, N-680-75M produced by DIC Corporation was used. N-680-75M is a solution composed of 75% by mass of a cresol novolac-type epoxy resin (solid content) and methyl ethyl ketone (MEK). As the curing agent, HPC-8000L-65MT produced by DIC Corporation was used. HPC-8000L-65MT is a solution composed of 65% by mass of an active ester-type curing agent (solid content), a toluene, and MEK.

A relative permittivity of the cured epoxy resin at 23±2° C. is 3.00 or more. That is, the epoxy resin used in Comparative Examples 6 and 7 does not correspond to a low-dielectric resin having a relative permittivity εᵣs of 2.00 or more and less than 3.00 at 23±2° C. However, the epoxy resin used in Comparative Examples 6 and 7 is formally represented as one kind of low-dielectric resin hereafter for convenience of description.

In step 3 of each of Examples 2 to 7 and Comparative Examples 1 to 7, the mass ratio (the volume ratio) of each of the low-dielectric resin and the hollow particles was adjusted to each value shown in Table 1 and Table 2 described below.

In step 4 of each of Comparative Examples 6 and 7, the raw material of the sealing portion was dried at 110° C. for 3 hours.

In step 5 (molding step) of each of Comparative Examples 6 and 7, the pressed raw material was heated at 150° C. for 1 hour and then heated at 200° C. for 2 hours.

In the cases of Comparative Examples 6 and 7, the sealing sheet in which the coil portions were sealed was dried at 110° C. for 3 hours in air. After drying in air, the sealing sheet in a vacuum dryer was heated at 150° C. for 1 hour and further heated at 200° C. for 2 hours to cure the resin in the sealing sheet.

Each step, each evaluation, and each measurement of each of Examples 2 to 7 and Comparative Examples 1 to 7 were performed by the same method as that in Example 1, except for the matters described above.

However, in the case of Comparative Example 3, since the mass ratio of the hollow particles was high, and a viscosity of the raw material (paste) of the sealing portion was too high, it was not possible to produce the sealing portion, and it was also not possible to perform the evaluations and the measurements described above.

In addition, in the cases of Comparative Examples 6 and 7, the measurements of the coefficient of thermal expansion and the three-point bending strength, and the evaluations of the thermal resistance and the transparency were not performed.

In any cases of Examples 2 to 7 and Comparative Examples 2 to 5, none of the appearance defect, the color change, and the deformation of the square bar due to the immersion in the solder bath occurred. In the case of Comparative Example 1, the appearance defect and the color change of the square bar did not occur, but the square bar was deformed due to the immersion in the solder bath.

Results of the evaluations and the measurements of each of Examples 1 to 5 and Comparative Examples 1 and 2 are shown in Table 1 described below.

Results of the evaluations and the measurements of each of Examples 6 and 7 and Comparative Examples 4 to 7 are shown in Table 2 described below

TABLE 1

| | | | | | | Relative | | | Coefficient | Three-point | | | | | |
|---|---|---|---|---|---|---|---|---|---|---|---|---|---|---|---|
| | | Mass ratio (%) | | Volume ratio (%) | | permittivity | | | of | bending strength | | | | | |
| | Low | Low | Hollow | Low | Hollow | εᵣ₂ | | | thermal | (MPa) | | | Q value | | |
| | dielectric | dielectric | parti- | dielectric | parti- | 3.4 | 5.3 | 7.0 | expansion | Average | Standard | Trans- | 3 | 5 | 7 |
| | resin | resin | cles | resin | cles | GHz | GHz | GHz | (ppm/K) | value | deviation | parency | GHz | GHz | GHz |
| Compar- | BMI- | 100 | 0 | 100 | 0 | 2.44 | 2.45 | 2.47 | 361 | 14.7 | 4.75 | Trans- | 35 | 43 | 48 |
| ative | 3000J | | | | | | | | | | | parent | | | |
| Example | | | | | | | | | | | | | | | |
| 1 | | | | | | | | | | | | | | | |
| Compar- | BMI- | 95 | 5 | 92.2 | 7.8 | 2.40 | 2.41 | 2.43 | 325 | 15.5 | 2.17 | Trans- | 37 | 45 | 50 |
| ative | 3000J | | | | | | | | | | | parent | | | |
| Example | | | | | | | | | | | | | | | |
| 2 | | | | | | | | | | | | | | | |
| Example | BMI- | 80 | 20 | 71.3 | 28.7 | 2.30 | 2.31 | 2.32 | 220 | 21.4 | 0.79 | Opaque | 44 | 53 | 59 |
| 1 | 3000J | | | | | | | | | | | | | | |
| Example | BMI- | 70 | 30 | 59.1 | 40.9 | 2.25 | 2.25 | 2.26 | 155 | 24.1 | 0.64 | Opaque | 46 | 56 | 63 |
| 2 | 3000J | | | | | | | | | | | | | | |
| Example | BMI- | | 50 | 38.3 | 61.7 | 2.13 | 2.14 | 2.15 | 72 | 26.9 | 0.91 | Opaque | 50 | 63 | 70 |
| 3 | 3000J | | | | | | | | | | | | | | |
| Example | BMI- | 40 | 60 | 29.2 | 70.8 | 2.06 | 2.07 | 2.08 | 43 | 25.1 | 1.19 | Opaque | 54 | 70 | 79 |
| 4 | 3000J | | | | | | | | | | | | | | |
| Example | BMI- | 30 | 70 | 21.0 | 79.0 | 2.01 | 2.02 | 2.03 | 33 | 18.8 | 1.64 | Opaque | 59 | 77 | 90 |
| 5 | 3000J | | | | | | | | | | | | | | |
| Compar- | BMI- | 20 | 80 | 13.4 | 83.6 | — | — | — | — | — | — | — | — | — | — |
| ative | 3000J | | | | | | | | | | | | | | |
| Example | | | | | | | | | | | | | | | |
| 3 | | | | | | | | | | | | | | | |

TABLE 2

| | | | | | | Relative | | | Coefficient | Three-point | | | | | |
|---|---|---|---|---|---|---|---|---|---|---|---|---|---|---|---|
| | | Mass ratio (%) | | Volume ratio (%) | | permittivity | | | of | bending strength | | | | | |
| | Low | Low | Hollow | Low | Hollow | εᵣ₂ | | | thermal | (MPa) | | | Q value | | |
| | dielectric | dielectric | parti- | dielectric | parti- | 3.4 | 5.3 | 7.0 | expansion | Average | Standard | Trans- | 3 | 5 | 7 |
| | resin | resin | cles | resin | cles | GHz | GHz | GHz | (ppm/K) | value | deviation | parency | GHz | GHz | GHz |
| Compar- | BMI- | 100 | 0 | 100 | 0 | 2.85 | 2.86 | 2.89 | 113 | 24.6 | 6.01 | Trans- | 32 | 39 | 42 |
| ative | 6100 | | | | | | | | | | | parent | | | |
| Example | | | | | | | | | | | | | | | |
| 4 | | | | | | | | | | | | | | | |
| Example | BMI- | 50 | 50 | 38.3 | 61.7 | 2.33 | 2.33 | 2.34 | 28 | 40.0 | 1.37 | Opaque | 43 | 52 | 58 |
| 6 | 6100 | | | | | | | | | | | | | | |
| Compar- | BMI- | 100 | 0 | 100 | 0 | 2.30 | 2.30 | 2.32 | 285 | 31.0 | 5.53 | Trans- | 43 | 53 | 60 |
| ative | 2500 | | | | | | | | | | | parent | | | |
| Example | | | | | | | | | | | | | | | |
| 5 | | | | | | | | | | | | | | | |
| Example | BMI- | 30 | 30 | 38.3 | 61.7 | 2.14 | 2.14 | 2.15 | 57 | 51.7 | 1.51 | Opaque | 50 | 62 | 70 |
| 7 | 2500 | | | | | | | | | | | | | | |
| Compar- | Epoxy | 100 | 0 | 100 | 0 | 3.97 | 3.97 | 3.96 | — | — | — | — | 28 | 30 | 27 |
| ative | | | | | | | | | | | | | | | |
| Example | resin | | | | | | | | | | | | | | |
| 6 | | | | | | | | | | | | | | | |
| Compar- | Epoxy | 80 | 20 | 66.3 | 33.7 | 3.22 | 3.22 | 3.21 | — | — | — | — | 30 | 33 | 32 |
| ative | | | | | | | | | | | | | | | |
| Example | resin | | | | | | | | | | | | | | |
| 7 | | | | | | | | | | | | | | | |

For example, the high-frequency coil component according to one aspect of the present disclosure is suitable for an inductor for a high-frequency circuit.

The technology according to the present disclosure includes the following configuration examples but not limited thereto.

[1] A high-frequency coil component, including: a sealing portion containing a resin and a plurality of hollow particles; and a coil portion composed of a wound conductive wire, in which the coil portion is sealed in the sealing portion, the resin includes a low-dielectric resin having a relative permittivity εᵣ₁ of 2.00 or more and less than 3.00 at 23±2° C., a mass of the resin is represented by Mr, a total mass of the plurality of hollow particles is represented by Mp, and Mr/(Mr+Mp) is 25% or more and 85% or less.

[2] The high-frequency coil component according to [1], in which a relative permittivity εᵣ₂ of the sealing portion at 23±2° C. is 1.00 or more and 2.34 or less.

[3] The high-frequency coil component according to [1] or [2], in which the low-dielectric resin includes a thermosetting polyimide.

[4] The high-frequency coil component according to [3], in which the thermosetting polyimide includes a polybismaleimide.

[5] The high-frequency coil component according to any one of [1] to [4], in which Mr/(Mr+Mp) is 30% or more and 70% or less.

[6] The high-frequency coil component according to any one of [1] to [5], in which a volume of the resin is represented by Vr, a total volume of the plurality of hollow particles is represented by Vp, and Vr/(Vr+Vp) is 17% or more and 78% or less.

[7] The high-frequency coil component according to [6], in which Vr/(Vr+Vp) is 20% or more and 60% or less.

[8] The high-frequency coil component according to any one of [1] to [7], in which the plurality of hollow particles include glass.

According to the disclosure, the opaque high-frequency coil component having a high mechanical strength and a high Q value is provided.

### REFERENCE SIGNS LIST

1: high-frequency coil component, 2: sealing portion, 3: terminal electrode, 4: resin, 6: hollow particles, 5: coil portion, 5a, 5b: extraction portion of coil portion.

What is claimed is:

1. A high-frequency coil component, comprising:
a sealing portion containing a resin and a plurality of hollow particles; and
a coil portion composed of a wound conductive wire,
wherein the coil portion is sealed in the sealing portion,
the resin includes a low-dielectric resin having a relative permittivity εᵣ₁ of 2.00 or more and less than 3.00 at 23±2° C.,
a mass of the resin is represented by Mr,
a total mass of the plurality of hollow particles is represented by Mp, and
Mr/(Mr+Mp) is 25% or more and 85% or less.

2. The high-frequency coil component according to claim 1,
wherein a relative permittivity εᵣ₂ of the sealing portion at 23±2° C. is 1.00 or more and 2.34 or less.

3. The high-frequency coil component according to claim 1,
wherein the low-dielectric resin includes a thermosetting polyimide.

4. The high-frequency coil component according to claim 3,
wherein the thermosetting polyimide includes a polybismaleimide.

5. The high-frequency coil component according to claim 1,
wherein Mr/(Mr+Mp) is 30% or more and 70% or less.

6. The high-frequency coil component according to claim 1,
wherein a volume of the resin is represented by Vr,
a total volume of the plurality of hollow particles is represented by Vp, and
Vr/(Vr+Vp) is 17% or more and 78% or less.

7. The high-frequency coil component according to claim 6,
wherein Vr/(Vr+Vp) is 20% or more and 60% or less.

8. The high-frequency coil component according to claim 1,
wherein the plurality of hollow particles include glass.
